(19) United States
(12) Patent Application Publication
(10) Pub. No.: US 2002/0167547 A1
(43) Pub. Date: Nov. 14, 2002

(54) Method of selecting object from multimedia contents encoded by object-based coding, and information processing apparatus adopting the method

(76) Inventors: Takeshi Ozawa, Tokyo (JP); Masahiko Takaku, Kanagawa (JP); Hajime Oshima, Tokyo (JP)

Correspondence Address: MORGAN & FINNEGAN, L.L.P., 345 PARK AVENUE, NEW YORK, NY, 10154, US

(21) Appl. No.: 10/086,351

(22) Filed: Feb. 28, 2002

(30) Foreign Application Priority Data
Mar. 2, 2001 (JP) 058747/2001(PAT.)

(51) Int. Cl. G09G 5/00

(52) U.S. Cl. 345/819

(57) ABSTRACT

This invention provides an object selection method which can easily select objects by simple, one-dimensional operations by sequentially changing an object to be selected in accordance with a given order or reference in response to a one-dimensional operation input from an operation input device, and an information processing apparatus that adopts the method. In an information processing apparatus for selecting an object set with an arbitrary function on a display screen, and executing the function, objects set with arbitrary functions are determined from multimedia contents encoded by object-based coding, the determined objects are controlled to be set in turn as an object to be selected by a pointer image by simple operation of a “next” or “back” button, and a process is executed by pressing an “OK” button.

### FIELD OF THE INVENTION

This invention relates to a method of selecting object from multimedia contents encoded by object-based coding and an information processing apparatus which adopts the method and, more particularly, to a method which is executed in response to operation at an information terminal upon browsing multimedia contents encoded by object-based coding, and an information processing apparatus which adopts the method.

### BACKGROUND OF THE INVENTION

Multimedia contents which are encoded by object-based coding such as MPEG-4 (Moving Picture Experts Group version 4) specified by ISO or a similar scheme are used in a user model in which the user selects, manipulates, and browses objects such as still images, moving images, and the like which are laid out in a two- or three-dimensional virtual space and are displayed on the display screen. Such contents can be easily and effortlessly used by a pointing method using a pointer which moves continuously (or sometimes in geometric progression) in the upper, lower, right, left, and oblique directions (two-dimensional directions) by an operation device represented by a mouse of a personal computer (PC) or a method that allows the user to directly select an object via a display device having an input function such as a touch panel.

On the other hand, a portable information terminal represented by a portable telephone having an information communication function is required to simplify an operation input device so as to achieve size and weight reductions for assuring portability and to attain component and manufacturing cost reductions. For this reason, the portable information terminal normally does not have any device such as a mouse or the like, which is normally used in a PC, and has a simple operation input device for a one-dimensional direction (e.g., “next” or “back”) such as “next” and “back” buttons, a jog dial, a scroll wheel, and the like. Since such simple operation device can be easily operated using only one finger, a compact portable terminal can be easily used anywhere of user's choice. Furthermore, since the operation method is simple and easy to understand for the user, an elderly person or the like who cannot easily get used to a complicated operation input device can easily operate and handle it.

In order to easily and kindly select objects of multimedia contents, which are encoded by object-based coding (e.g., MPEG-4) and are laid out on the display screen, a method of pointing a two-dimensional display region of an object using an operation device that can smoothly select desired coordinates on the screen in the two-dimensional direction is effective.

However, a simple operation input device such as a button device requires the user to make operations a relatively larger number of times, and it becomes difficult to easily designate a two-dimensional coordinate region of an object which is laid out at an arbitrary position for respective contents. In the method of designating two-dimensional coordinates, since the user directly designates these coordinates, operation for pointing a region other than a target object is also required. Such operation for pointing a region other than a target object is unnecessary in terms of the original purpose of the user who requests to execute a provided operation, thus increasing the number of times of operations of the user. Therefore, it is very difficult to kindly use object-based encoded multimedia contents using the conventional method for designating a two-dimensional coordinate region where an object is laid out in a portable information terminal that can only comprise a simple operation input device in practice.

### SUMMARY OF THE INVENTION

It is an object of the present invention to provide a method which can easily select an object by simple one-dimensional operation by sequentially changing an object to be selected in accordance with a given order or reference in response to a one-dimensional operation input from an operation input device in place of the selection method of designating a layout region of an object, and an information processing apparatus which adopts that method.

Note that the object to be selected is an object set with an arbitrary function. Also, the present invention provides a mechanism for automatically selecting the object to be selected in response to user's operation input and informing the user of the selected object. That is, since an object to be selected is limited to the object itself, which is assigned a given function, the number of times of operations required to select an operation can be minimized, and a simple operation device like a button device can sufficiently attain such operations.

In order to achieve the above object, an information processing apparatus of the present invention is an information processing apparatus for selecting an object set with a function on a display screen, and executing the function, comprising: determination means for determining objects each set with a function from multimedia contents encoded by object-based coding; and control means for controlling the objects determined by the determination means so that each of the object is to be selected in turn.

Note that the apparatus further comprises order setting means for setting a selection order of the objects determined by the determination means, and the control means sets the objects as the object to be selected in turn in accordance with the set selection order. The order setting means detects an order in which objects appear, an order in which objects are laid out vertically, or an order in which objects are laid out horizontally, and sets the selection order on the basis of the detected order. The control means comprises instruction means for instructing one of the objects determined by the determination means as the object to be selected. The control means comprises means for changing an instruction of the object to be selected by the instruction means in accordance with the selection order set by the order setting means. The apparatus further comprises means for identifiably informing a user of the object instructed as the object to be selected by the instruction means. The means for changing the instruction includes a button for switching the object to be selected by one touch in accordance with the selection order. The object-based coding includes MPEG-4.

A method of the present invention comprises the steps of: determining objects set with a function from multimedia contents encoded by object-based coding; and controlling to set the determined objects so that each of the object is to be selected in turn.

Note that the method further comprises the step of setting a selection order of the determined objects, and the objects are set as the object to be selected in turn in accordance with the set selection order. The order setting step includes the step of detecting an order in which objects appear, an order in which objects are laid out vertically, or an order in which objects are laid out horizontally, and setting the selection order on the basis of the detected order. The method further comprises the step of identifiably informing a user of the object which is set as the object to be selected. The object to be selected is switched by a button for switching the object to be selected by one touch in accordance with the selection order. The object-based coding includes MPEG-4.

A storage medium of the present invention is a storage medium for computer-readably storing a control program for controlling an information processing apparatus for selecting an object set with a function on a display screen, and executing the function, the control program comprising: the determination step of determining objects each set with a function from multimedia contents encoded by object-based coding; and the control step of controlling the determined objects so that each of the object is to be selected in turn. Note that the control program further comprises the step of setting a selection order of the determined objects, and the control step includes the step of setting the objects as the object to be selected in turn in accordance with the set selection order.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 shows an example of the outer appearance of an information terminal in an embodiment of the present invention;

FIG. 2 is a block diagram showing an example of the arrangement of the information terminal in the embodiment of the present invention;

FIG. 3 is a flow chart showing an example of the operation sequence in the embodiment of the present invention;

FIG. 4 is a flow chart showing an example of the operation sequence of step S206 in FIG. 3;

FIG. 5 shows an example of a sensor object list and point image object information in the embodiment of the present invention; and

FIG. 6 shows an example of a screen display upon using multimedia contents in the embodiment of the present invention.

### DETAILED DESCRIPTION OF THE PREFERRED EMBODIMENTS

A preferred embodiment of the present invention will be described hereinafter. In the embodiment to be described below, MPEG-4 is used as an encoding scheme of multimedia contents having an object-based encoding mechanism. However, the encoding scheme is not limited to MPEG-4, the present invention can be applied to encoding schemes that belong to object-based encoding, and the same effects can be obtained in this case. Such methods are included in the scope of the present invention.

<Description of Outline of MPEG-4>

In MPEG-4, a function and configuration of an object to be used are described using a format called BIFS (Binary Format for Scenes) . In BIFS, each object is handled as a node, and all nodes become elements which form a tree structure having a parent-child relationship. In MPEG-4, a plurality of types of nodes having various characteristics are defined, and a node having a function of externally informing selection by an arbitrary method among these nodes is called a sensor node. Also, a node which is similar to the sensor node and has a function of externally bidding to call a designated object or contents when it is selected by the user is called an anchor node. For the sake of simplicity, in this embodiment, an object defined as a sensor or anchor node by BIFS will be referred to as a “sensor object”. When selection of a sensor object is externally informed, an operation pre-set for that sensor object is executed.

<Example of Arrangement of Information Terminal of This Embodiment>

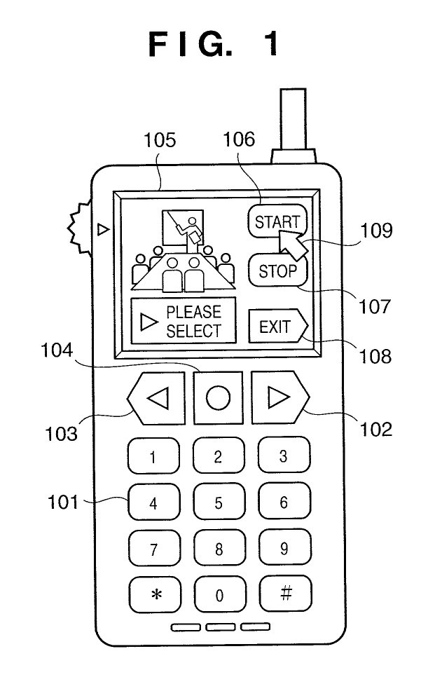

FIG. 1 shows an example of the outer appearance of an information terminal as an information processing apparatus having a simple operation device in this embodiment.

Referring to FIG. 1, reference numeral 101 denotes number input buttons. Reference numeral 102 denotes a “next” button; and 103, a “back” button, which buttons are used in a one-dimensional operation. Reference numeral 104 denotes an “OK” button. Reference numeral 105 denotes a display device for displaying MPEG-4 contents used.

FIG. 1 shows a state wherein the user is browsing MPEG-4 contents, and some objects are displayed. In the example shown in FIG. 1, sensor objects having a selection informing function among the displayed objects are Start 106, Stop 107, and Exit 108. Selectable objects are selected in turn by pressing buttons 102 and 103 in an arbitrary one-dimensional direction, and selection is determined by pressing the button 104. Displayed non-sensor objects other than Start 106, Stop 107, and Exit 108 are not selected.

As a method of informing the user of the selected object, a method of bounding the selected object by a bold frame, wavy line, double-line, or the like, a method of displaying an image that points to the selected object, and the like may be used. This embodiment uses a method of displaying a point image 109 in FIG. 1. Note that this selection informing method is not the gist of the present invention, and any other methods may be used.

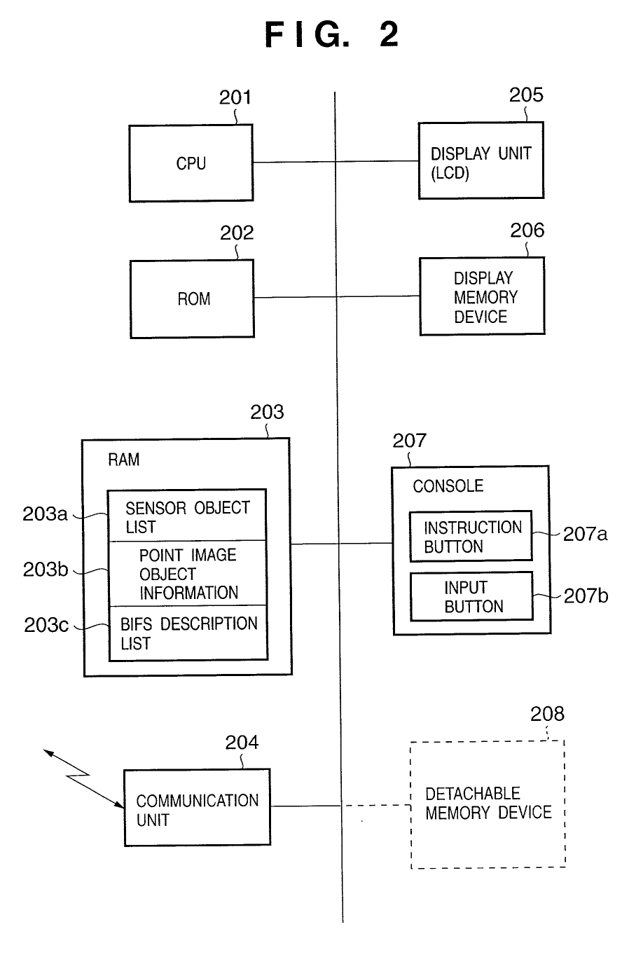

FIG. 2 is a block diagram showing an example of the internal arrangement of the information terminal as an information processing apparatus having a simple operation device in this embodiment.

The information terminal comprises a ROM (Read Only Memory) 202, which records an MPEG-4 viewer program used to execute MPEG-4 rendering, basic software for controlling that program and the information terminal itself, and the like. Also, the information terminal comprises a CPU 201 for executing such software, a RAM (Random Access memory) 203 for temporarily storing various data upon executing arithmetic operations, a memory device 206 for display on a display (display unit) 205, and a console 207 including a controller for controlling a button input, and the like.

The RAM 203 stores, e.g., a sensor object list table 203a, information 203b associated with a point image object, a BIFS description list 203c that describes the currently displayed screen contents (to be described later), and the like in this embodiment. The console 207 has instruction buttons 207a including the buttons 102 to 104, and input buttons 207b including the number input buttons 101.

Furthermore, the information terminal comprises a communication unit 204 for controlling a wireless communication function of the information terminal, and a memory device 208 which can detachably receive a memory card, CD, MO, or the like.

<Example of Operation Sequence of This Embodiment>

The sequence of an operation executed by the MPEG-4 viewer program in response to one-dimensional operation of the operation device will be explained below.

In this embodiment, a selection order is determined with reference to the display coordinate positions of sensor objects. For example, a selection method with reference to the display coordinate positions of objects, a selection method based on the order in which objects are described, and the like may be used. In this embodiment, the upper left corner of the display screen is defined as an origin, X- and Y-coordinates are respectively plotted in the right and down directions, an object having an upper display coordinate position (smaller Y-coordinate) is selected earlier, and an object having a display coordinate position closer to the left end (smaller X-coordinate) is selected earlier if objects are located at the same level. Note that this order need not be limited to the example of this embodiment, and various orders may be used (for example, the select position may shift to go round on the display screen, or the select position may shift in descending order of frequency of use or importance).

In this embodiment, when the user begins to use contents, a sensor object is searched for, and a sensor object having the first selection order is set in a select state. When the “next” button is pressed while a sensor object with the last selection order is selected, the selection position shifts to the sensor object having the first selection order. Likewise, when the “back” button is pressed while the sensor object having the first selection order is selected, the selection position shifts to the sensor object having the last selection order. However, such sensor object selection determination method is not particularly limited.

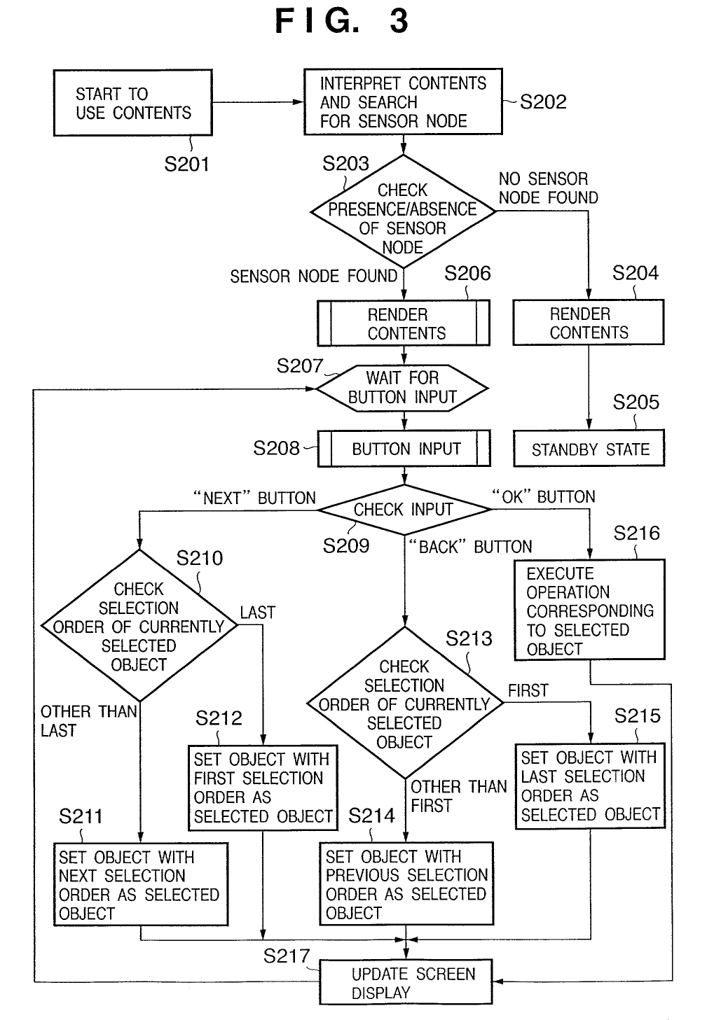

FIG. 3 is a flow chart showing an example of the operation sequence in response to one-dimensional button operations in this embodiment.

If the user operates the information terminal and begins to use contents (S201), the MPEG-4 viewer program interprets the contents and searches for a sensor node (S202), and checks the presence/absence of a sensor object defined as a sensor or anchor node by BIFS (S203). If none of the objects are sensor objects, the viewer program executes and renders the contents (S204), and is set in a standby state after completion of the operation (S205).

If sensor objects are found, the viewer program sets the selection order of these sensor objects, and waits for a button input (S207) after it renders contents on the display 105 (display unit 205) (S206). Note that the process for setting the selection order of sensor objects in step S206 and a process for setting a point image in this example will be explained later. If the user has pressed one of the operation buttons (S208), the viewer program receives input information, and checks the pressed button (S209).

If the “next” button has been pressed, the selection order of the currently selected sensor object is checked (S210). If the current selection order is not the last one, a sensor object of the next selection order is set as an object to be selected (S211), and the display contents on the display are updated (S217). Conversely, if the selection order of the currently selected sensor object is the last one, a sensor object having the first selection order is set as an object to be selected (S212), and the display contents on the display are updated (S217).

If the “back” button has been pressed, the selection order of the currently selected sensor object is checked (S213). If the current selection order is not the first one, a sensor object of the previous selection order is set as an object to be selected (S214), and the display contents on the display are updated (S217). On the other hand, if the current selection order is the first one, a sensor object of the last selection order is set as an object to be selected (S215), and the display contents on the display are updated (S217).

If the “OK” button has been pressed, an operation set for the currently selected sensor object is executed (S216), and the display contents on the display are updated in accordance with the execution result (S217).

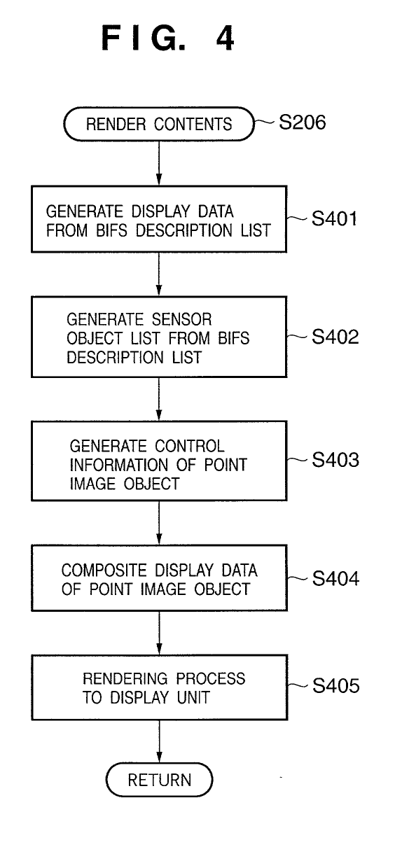

FIG. 4 is a flow chart showing an example of the operation sequence for setting the selection order of sensor objects in step S206 in FIG. 3, and setting a point image in this example.

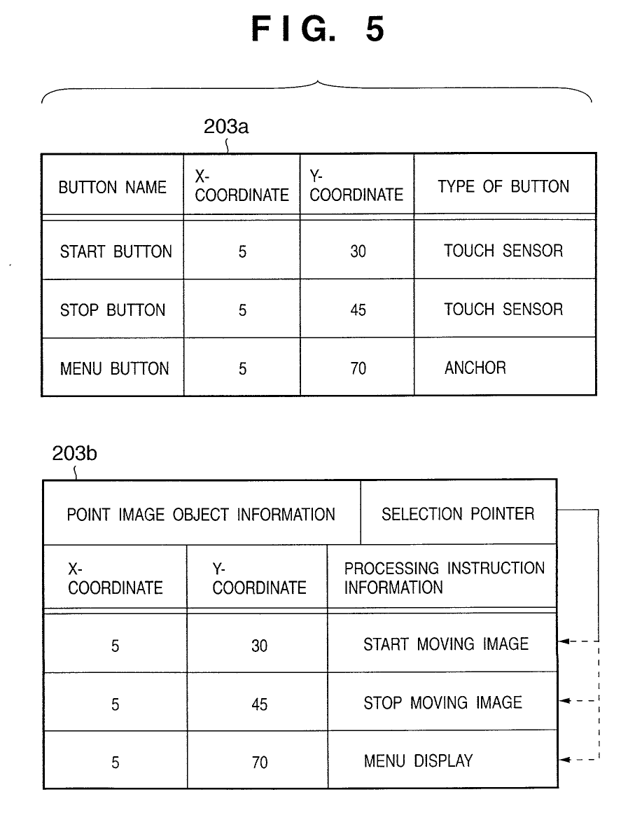

If it is determined based on the BIFS interpretation result that sensor objects are found, display data is generated from a BIFS description list, and is stored in the display memory device 206 (S401). Sensor objects are extracted from the BIFS description list to generate a list table 203a shown in FIG. 5 (S402). Upon generating this list table, the selection order of sensor objects is determined. In this example, the order is determined based on the X- and Y-coordinates on the display screen, and the list table is generated in that selection order. Note that sensor objects may be stored in the list table irrespective of their order, and may be linked in the selection order, or the list table may store only extracted sensor objects.

In this example, control information used to display a point image object (point image 109 in FIG. 1) and to control upon pressing the “OK” button is generated (S403). For example, as indicated by 203b in FIG. 5, the control information stores the coordinates of sensor objects extracted by BIFS interpretation in the order they are to be selected, and instruction information (e.g., pointers, subroutine names, and the like) of processes to be executed upon pressing the “OK” button. These sensor objects are selected by a selection pointer in turn in response to pressing of the “next” and “back” buttons. Then, the point image 109 (an arrow cursor in this example) is generated, and is composited to coordinates corresponding to the display coordinates of the sensor object (S404). An image, which is stored in the display memory device 206 and is composited with the point image 109, is displayed.

<Example of Contents of This Embodiment>

An example of the operation upon using multimedia contents on the information terminal of this embodiment will be explained below. A case will be described below wherein a BIFS description that sets the configuration information and node characteristics of objects of MPEG-4 contents is an example of list 1 to be described later.

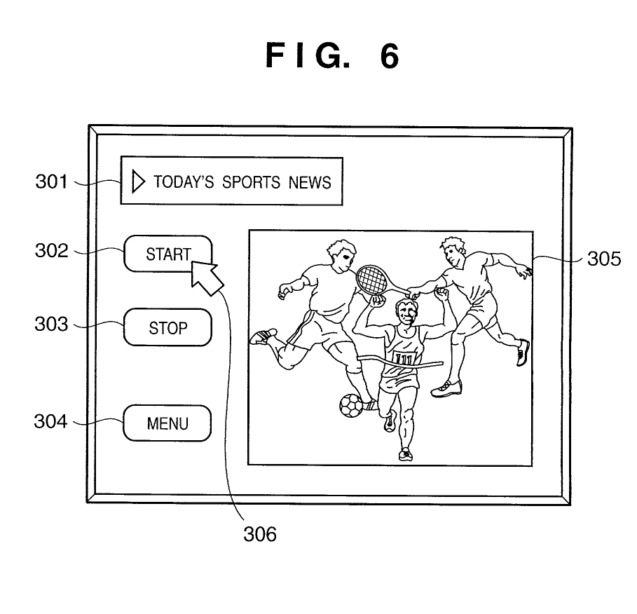

FIG. 6 shows the screen display contents of the MPEG-4 contents of this example based on list 1.

The displayed contents are formed of a background image, text 301, three image objects 302, 303, and 304, and moving image object 305. Reference numeral 306 denotes a pointer image for informing the user of the selected sensor object.

In list 1 of the BIFS description, the text object 301 corresponds to a BIFS description from the third to 13th lines of list 1. The image object 302 corresponds to a BIFS description from the 14th to 28th lines of list 1. The image object 303 corresponds to a BIFS description from the 29th to 43rd lines of list 1. The image object 304 corresponds to a BIFS description from the 48th to 61st lines of list 1. The moving image object 305 corresponds to a BIFS description from the 64th to 78th lines of list 1. The image objects 302, 303, and 304 are respectively defined to display button images shown in FIG. 6 in the descriptions of the 22nd, 37th, and 56th lines of list 1.

The objects 302 and 303 are defined as touch sensor nodes, which belong to a sensor node, in the 26th and 41st lines of list 1. Also, the object 304 is defined as an anchor node in the 44th line. Therefore, sensor objects in this embodiment are the image objects 302, 303, and 304. The layout coordinates of these sensor objects are set in the 15th line (302), 30th line (303), and 49th line (304), and the selection order of the sensor objects in this embodiment is 302→303→304 based on these layout coordinates.

The operation executed upon selecting and determining the image object 302 is defined to start playback of a moving image of the moving image object 305 in the 84th line of list 1. The operation executed upon selecting and determining the image object 303 is defined to stop playback of the moving image of the moving image object 305 in the 85th line of list 1. The operation executed upon selecting and determining the image object 304 is defined to call MPEG-4 contents named “menu.mp4” designated in the 46th line of list 1.

FIG. 5 shows an example of the sensor object list table generated based on list 1, and information 203b associated with the point image object.

The object list table 203a stores the layout coordinates of the sensor objects, which are determined from the 15th 30th, and 49th lines of list 1, in the determined selection order, i.e., in the order of image objects 302→303→304. The information 203b associated with the point image object similarly stores the layout coordinates in the order of image objects 302→303→304, and also instruction information of processes to be executed upon pressing the corresponding buttons, and the selection pointer indicates the button currently pointed by the point image object 306. This indication is changed in the predetermined order upon pressing the “next” button 102 or “back” button 103 in FIG. 1.

In FIG. 5, a list of sensor objects is generated, and sensor objects to be pointed by the point image objects are stored in the form of a list. Alternatively, only the currently pointed sensor object may be stored.

In practice, when the user begins to use contents, the point image object 306 is rendered to point to the image object 302 as the sensor object with the first selection order. Upon pressing the “next” button 102, the point image object 306 is laid out and rendered on the screen to point to the image object 303 as the sensor object with the next selection order. When the button 102 is repetitively pressed, the point image object 306 is rendered on the screen while changing its location to point to the image object in the order of 304→302→303→304. On the other hand, every time the “back” button 103 is pressed, the point image object 306 is rendered on the screen while changing its location to point in turn to the image objects in the order of 304 303→302→304.

When the user determines selection while the image object 302 is selected, playback of the moving image of the moving image object 305 is started as an operation described by BIFS in list 1. When the user determines selection while the image object 303 is selected, playback of the moving image of the moving image object 305 is stopped as an operation described by BIFS in list 1. Furthermore, when the user determines selection while the image object 304 is selected, MPEG-4 contents named “menu.mp4” are called as an operation described by BIFS in list 1.

<List 1: Definition Contents of Object Characteristics of Multimedia Contents Used in Embodiment of Present Invention>

| | |
|---|---|
| 1: | Group { |

| | |
|---|---|
| 2: | children [ |

| | |
|---|---|
| 3: | Transform2D { |

| | |
|---|---|
| 4: | translation 10 5 |
| 5: | children [ |

| | |
|---|---|
| 6: | Shape { |

| | |
|---|---|
| 7: | geometry Text { |

| | |
|---|---|
| 8: | maxExtent 20 |
| 9: | string “Today's Sports News” |

| | |
|---|---|
| 10: | } |

| | |
|---|---|
| 11: | } |

| | |
|---|---|
| 12: | ] |

| | |
|---|---|
| 13: | } |
| 14: | Transform2D { |

| | |
|---|---|
| 15: | translation 5 30 |
| 16: | children [ |

| | |
|---|---|
| 17: | Shape { |

| | |
|---|---|
| 18: | geometry Bitmap {} |
| 19: | appearance Appearance { |

| | |
|---|---|
| 20: | material Material2D {} |
| 21: | texture ImageTexture { |

| | |
|---|---|
| 22: | url “start_button.jpg” |

| | |
|---|---|
| 23: | } |

| | |
|---|---|
| 24: | } |

| | |
|---|---|
| 25: | } |
| 26: | DEF TS1 TouchSensor {} |

| | |
|---|---|
| 27: | ] |

| | |
|---|---|
| 28: | } |
| 29: | Transform2D { |

| | |
|---|---|
| 30: | translation 5 45 |
| 31: | children [ |

| | |
|---|---|
| 32: | Shape { |

| | |
|---|---|
| 33: | geometry Bitmap {} |
| 34: | appearance Appearance { |

| | |
|---|---|
| 35: | material Material2D {} |
| 36: | texture ImageTexture { |

| | |
|---|---|
| 37: | url “stop_button.jpg” |

| | |
|---|---|
| 38: | } |

| | |
|---|---|
| 39: | } |

| | |
|---|---|
| 40: | } |
| 41: | DEF TS2 TouchSensor {} |

| | |
|---|---|
| 42: | ] |

| | |
|---|---|
| 43: | } |
| 44: | Anchor { |

| | |
|---|---|
| 45: | description “menu” |
| 46: | url “menu.mp4” |
| 47: | children [ |

| | |
|---|---|
| 48: | Transform2D { |

| | |
|---|---|
| 49: | translation 5 70 |
| 50: | children [ |

| | |
|---|---|
| 51: | Shape { |

| | |
|---|---|
| 52: | geometry Bitmap {} |
| 53: | appearance Appearance { |

| | |
|---|---|
| 54: | material Material2D {} |
| 55: | texture ImageTexture { |

| | |
|---|---|
| 56: | url “menu_button.jpg” |

| | |
|---|---|
| 57: | } |

| | |
|---|---|
| 58: | } |

| | |
|---|---|
| 59: | } |

| | |
|---|---|
| 60: | ] |

| | |
|---|---|
| 61: | } |

| | |
|---|---|
| 62: | ] |

| | |
|---|---|
| 63: | } |
| 64: | Transform2D { |

| | |
|---|---|
| 65: | translation 40 30 |
| 66: | children [ |

| | |
|---|---|
| 67: | Shape { |

| | |
|---|---|
| 68: | geometry Bitmap {} |
| 69: | appearance Appearance { |

| | |
|---|---|
| 70: | material Material {} |
| 71: | texture DEF MT MovieTexture { |
| 72: | starttime −1 |
| 73: | url “sports_news.bits” |

| | |
|---|---|
| 74: | } |

| | |
|---|---|
| 75: | } |

| | |
|---|---|
| 76: | } |

| | |
|---|---|
| 77: | ] |

| | |
|---|---|
| 78: | } |

| | |
|---|---|
| 79: | ] |

| | |
|---|---|
| 80: | } |
| 81: | Backgound2D { |

| | |
|---|---|
| 82: | url “background.jpg” |

| | |
|---|---|
| 83: | } |
| 84: | ROUTE TS1.touchTime TO MT.startTime |
| 85: | ROUTE TS2.touchTime TO MT.stopTime |

As described above, the encoding scheme is not limited to MPEG-4, the present invention can be applied to encoding schemes that belong to object-based encoding, and the same effects can be obtained in this case. Such methods are included in the scope of the present invention.

The objects of the present invention are also achieved by supplying a storage medium (or recording medium), which records a program code of a software program that can implement the functions of the above-mentioned embodiments to the system or apparatus, and reading out and executing the program code stored in the storage medium by a computer (or a CPU or MPU) of the system or apparatus. In this case, the program code itself read out from the storage medium implements the functions of the above-mentioned embodiments, and the storage medium which stores the program code constitutes the present invention. The functions of the above-mentioned embodiments may be implemented not only by executing the readout program code by the computer but also by some or all of actual processing operations executed by an operating system (OS) running on the computer on the basis of an instruction of the program code.

Furthermore, the functions of the above-mentioned embodiments may be implemented by some or all of actual processing operations executed by a CPU or the like arranged in a function extension card or a function extension unit, which is inserted in or connected to the computer, after the program code read out from the storage medium is written in a memory of the extension card or unit.

When the present invention is applied to the storage medium, that storage medium stores program codes corresponding to the aforementioned flow charts (shown in FIG. 3 and/or FIG. 4). For example, the storage medium is the detachable memory device 208 such as a memory card, CD, MO, DVD, or the like shown in FIG. 2, and can be used as an auxiliary medium or as a personal information portable medium to also serve as the ROM 202 and RAM 203, or the display memory device 206.

The present invention can provide an object selection method which can easily select objects by simple, one-dimensional operations by sequentially changing an object to be selected in accordance with a given order or reference in response to a one-dimensional operation input from an operation input device in place of a selection method by designating a layout region of an object, and an information processing apparatus that uses the method.

More specifically, objects of multimedia contents encoded by object-based coding (e.g., MPEG-4) can be easily and effortlessly selected using a simple operation device. At the same time, an information terminal which is equipped with only a simple operation device allows the user to use multimedia contents encoded by object-based coding (e.g., MPEG-4).

As many apparently widely different embodiments of the present invention can be made without departing from the spirit and scope thereof, it is to be understood that the invention is not limited to the specific embodiments thereof except as defined in the appended claims.

What is claimed is:

1. An information processing apparatus for selecting an object set with a function on a display screen, and executing the function, comprising:
determination means for determining objects each set with a function from multimedia contents encoded by object-based coding; and
control means for controlling the objects determined by said determination means so that each of the object is to be selected in turn.

2. The apparatus according to claim 1, further comprising order setting means for setting a selection order of the objects determined by said determination means, and
wherein said control means sets the objects as the object to be selected in turn in accordance with the set selection order.

3. The apparatus according to claim 2, wherein said order setting means detects an order in which objects appear, an order in which objects are laid out vertically, or an order in which objects are laid out horizontally, and sets the selection order on the basis of the detected order.

4. The apparatus according to claim 2, wherein said control means comprises instruction means for instructing one of the objects determined by said determination means as the object to be selected.

5. The apparatus according to claim 4, wherein said control means comprises means for changing an instruction of the object to be selected by said instruction means in accordance with the selection order set by said order setting means.

6. The apparatus according to claim 5, further comprising means for identifiably informing a user of the object instructed as the object to be selected by said instruction means.

7. The apparatus according to claim 5, wherein said means for changing the instruction includes a button for switching the object to be selected by one touch in accordance with the selection order.

8. The apparatus according to claim 1, wherein the object-based coding includes MPEG-4.

9. The apparatus according to claim 1, wherein said multimedia contents encoded by object-based coding include BIFS data, and said determination means determines objects based on said BIFS data.

10. A method of selecting object comprising the steps of:
determining objects each set with a function from multimedia contents encoded by object-based coding; and
controlling the determined objects so that each of the objects is to be selected in turn.

11. The method according to claim 10, further comprising the step of setting a selection order of the determined objects, and
wherein the objects are set as the object to be selected in turn in accordance with the set selection order.

12. The method according to claim 11, wherein the order setting step includes the step of detecting an order in which objects appear, an order in which objects are laid out vertically, or an order in which objects are laid out horizontally, and setting the selection order on the basis of the detected order.

13. The method according to claim 10, further comprising the step of identifiably informing a user of the object which is set as the object to be selected.

14. The method according to claim 11, wherein the object to be selected is switched by a button for switching the object to be selected by one touch in accordance with the selection order.

15. The method according to claim 10, wherein the object-based coding includes MPEG-4.

16. The method according to claim 10, wherein said multimedia contents encoded by object-based coding include BIFS data, and in said determination step, objects are determined based on said BIFS data.

17. A storage medium for computer-readably storing a control program for controlling an information processing apparatus for selecting an object set with a function on a display screen, and executing the function,
said control program comprising:
the determination step of determining objects each set with a function from multimedia contents encoded by object-based coding; and
the control step of controlling the determined objects so that each of the object is to be selected in turn.

18. The medium according to claim 17, further comprising the step of setting a selection order of the determined objects, and
wherein the control step includes the step of setting the objects as the object to be selected in turn in accordance with the set selection order.
